(19) United States
(12) Patent Application Publication
(10) Pub. No.: US 2009/0119748 A1
(43) Pub. Date: May 7, 2009

(54) System management mode isolation in firmware

(76) Inventors: Jiewen Yao, Shanghai (CN); Vincent J. Zimmer, Washington, WA (US); Qin Long, Shanghai (CN)

Correspondence Address: INTEL CORPORATION;c/o CPA Global, P.O. BOX 52050, MINNEAPOLIS, MN, 55402, US

(21) Appl. No.: 12/317,446

(22) Filed: Dec. 23, 2008

Related U.S. Application Data
(63) Continuation-in-part of application No. 11/897,355, filed on Aug. 30, 2007.

(51) Int. Cl. G06F 21/00

(52) U.S. Cl. 726/2

(57) ABSTRACT

A system, method, and computer-readable medium with instructions for capturing a system management interrupt instruction by trusted system management mode code running in a system. The system management interrupt instruction is dispatched to other system management mode code, which may be untrusted. In response to an attempt to access a protected resource of the system by the other system management mode code, a determination is made whether the second system management mode code is authorized to access the protected resource. If the second system management mode code is not authorized to access the protected resource, access to the protected resource by the other system management mode code is prevented. Other embodiments are described and claimed.

### CROSS REFERENCE TO RELATED APPLICATIONS

This application is a continuation-in-part of co-pending U.S. patent application Ser. No. 11/897,355, filed Aug. 30, 2007 and entitled “Method for Firmware Isolation,” which is assigned to the assignee of the present application and is incorporated by reference herein in its entirety.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### TECHNICAL FILED

The present disclosure relates generally to protection of code running in a privileged environment.

### BACKGROUND

System Management Mode (SMM) is a mode of operation of a computer system first released with the Intel 386SL and available in later microprocessors in subsequent Intel architectures. In SMM, all normal execution (including the operating system) is suspended, and special separate software (usually firmware or a hardware-assisted debugger) is executed in high-privilege mode. SMM provides an isolated memory and execution environment, and SMM code is invisible to the operating system yet retains full access to host physical memory and complete control over peripheral hardware.

SMM is normally used to handle system events such as memory or chipset errors; to perform system safety functions, such as shutdown upon reaching a high CPU temperature; to perform power management operations, such as turning on fans; to configure the system; and to emulate hardware. Traditionally, SMM is entered to provide service to system management interrupts and then resumes program execution (back to the software stack including executive and application software). Typically, the Basic Input/Output System (BIOS) does not restrict operation of the system while in SMM. Consequently, a danger exists that malware may infect firmware or a hardware-assisted debugger running in SMM, be difficult to detect, and may operate uninhibited by normal system safeguards such as virus protection software.

### BRIEF DESCRIPTION OF THE DRAWINGS

FIG. 1 is a system block diagram in accordance with an embodiment of the present invention.

FIG. 2 shows a hierarchy of privilege and resource protection of components of the system of FIG. 1 in accordance with one embodiment of the invention.

FIG. 3 is a flowchart of the initialization of the SMM environment of FIG. 1.

FIG. 4 is a block diagram of protection of page tables in accordance with an embodiment of the present invention.

FIG. 5 is a block diagram showing runtime operation of a SMM transfer monitor in the SMM environment of FIG. 1 in accordance with an embodiment of the invention.

FIG. 6 is another block diagram showing runtime operation of a SMM transfer monitor in the SMM environment of FIG. 1 while processing a security violation in accordance with an embodiment of the invention.

FIG. 7 is a flowchart showing protection of resources by the SMM transfer monitor of the present invention, in accordance with one embodiment of the invention.

### DETAILED DESCRIPTION

In many systems, trusted code, such as code present in a non-volatile storage of the system provided by an original equipment manufacturer (OEM), operates in the same privilege level as third party code, such as device drivers, that are loaded from disks or peripheral devices. Accordingly, there is a risk that untrusted or errant third party code can corrupt the system, particularly in a pre-boot environment prior to loading the operating system. To mediate this risk, Unified Extensible Firmware Interface (UEFI) code in accordance with the UEFI Specification Version 2.0 (dated Feb. 21, 2006) calls for the separation of pre-boot and boot environments into a variety of phases. However, in these phases both trusted code and third party untrusted/errant code can execute in the same privilege level.

To date, untrusted code running prior to loading an operating system has been isolated from trusted code via mechanisms such as System Management Mode (SMM). The use of SMM to perform pre-OS isolation highlights the need to protect code running in SMM from untrusted content as well. Because code running in SMM has unrestricted access to system memory and peripheral devices, the use of resources such as System Management Random Access Memory (SMRAM) by SMM code should also be protected. For example, in Intel's Core i7 processor, a region of at least four megabytes of SMRAM is reserved for an enhanced debug SMM module. This region of SMRAM should also be protected from being overwritten by untrusted code running in SMM.

The possibility of malware infecting SMM code was presented at the BlackHat 2008 conference in a presentation entitled “A New Breed of Rootkit: The System Management Mode (SMM) Rootkit.” See www.blackhat.com\html\bh-usa-08\bh-usa-08\-speakers.html (where “\” has been used to replace “/” in the URL). A proof of concept SMM rootkit was presented with purported functionality as a chipset level key logger. The SMM rootkit was described as hiding its memory footprint, making no changes to the host operating system, and being capable of covertly exfiltrating sensitive data across the network while evading host-based intrusion detection systems and firewalls.

The present invention provides a solution to threats such as the SMM rootkit presented at BlackHat 2008. Embodiments may use virtualization technology, such as available in processors from Intel Corporation, e.g., a so-called virtualization technology VT-x (or VTX) for x64 processors and VT-I for Itanium® processors. A virtual machine monitor (VMM) can act as a host to multiple virtual machines, and each virtual machine can support its own software stack of executive and application software.

To provide the functionality to isolate trusted SMM code from untrusted SMM code, two virtual machine monitors can be used. A first VMM operates outside of SMM to provide basic virtualization services, and another VMM operates inside SMM to support system management operations. This SMM dual, parallel, or “peer” monitor, referred to herein as an SMM Transfer Monitor (STM), is used to provide an execution environment that can isolate trusted SMM code from untrusted SMM code, such as a PCI bus driver loaded from disk.

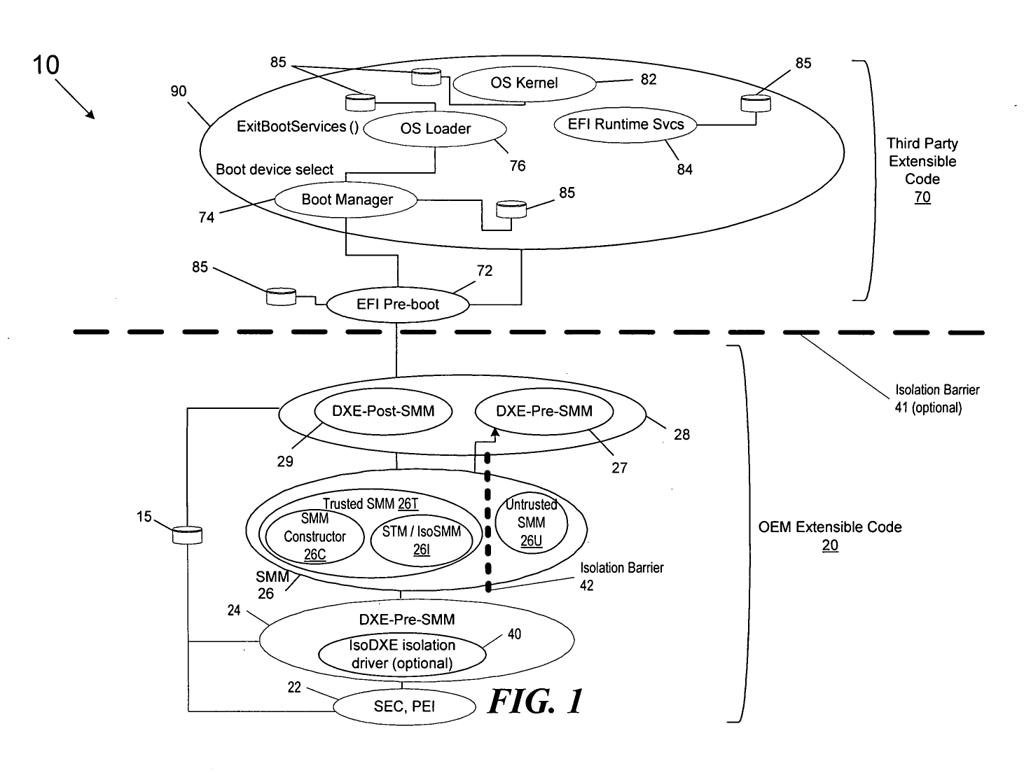

Referring to FIG. 1, in an SMM environment 26 provided in a system 10, a line illustrates an isolation barrier 42 between trusted SMM code 26T and untrusted SMM code 26U. Trusted SMM code 26T may include a trusted SMM constructor 26C, which provides initialization of the SMM environment, and an SMM transfer monitor (STM)/isolation driver IsoSMM 26I. Other objects (not shown) that may be considered to be trusted components include heap and stack objects used by the STM, as well as reserved memory areas used by the trusted SMM code 26T. Trusted SMM code 26T provides isolation barrier 42 by running the untrusted SMM code 26U at a lower privilege level than the trusted SMM code 26T. Isolation barrier 42 is erected prior to launching any code that is within untrusted SMM code 26U, including SMM code from an OEM of the platform or third party SMM code. Because code running in SMM persists into runtime after the operating system takes control and can be provided by many different parties, the present invention provides stringent protection for trusted SMM code 26T.

Because of space constraints in today's read only memory (ROMs), the implementation of an SMM transfer monitor (STM) may act as an isolation kernel that maps the machine memory in a 1:1 virtual-to-physical mapping without device emulation, versus a full hypervisor (HV) or virtual machine monitor (VMM) that provides non-1:1 memory mapping and rich device models.

In implementations executing under a UEFI model, first a security phase (SEC) may occur upon machine start or restart. In this security phase, initial operations after platform reset or power on may be performed to ensure firmware integrity is intact. Then a pre-EFI initialization environment (PEI) may be performed in which code may perform minimal processor, chipset and platform configuration to support memory discovery. Then a driver execution environment (DXE) phase may be performed. In this phase, much of firmware code may operate in the pre-boot environment. Such code may be implemented as multiple drivers, which complete initialization of the platform and devices. For example, device, bus or service drivers may be executed responsive to dispatch by a DXE dispatcher.

Isolation barrier 42 may be provided by an SMM isolation driver in a standard driver execution environment (DXE) environment. Alternatively, in one embodiment, isolation drivers may include functionality to isolate both driver execution environment (DXE) and SMM code, where the functionality to isolate DXE code (IsoDXE) is implemented as described in patent application Ser. No. 11/897,355, referenced above. This IsoDXE isolation driver, shown as IsoDXE isolation driver 40 in FIG. 1, is optional for purposes of the present invention and provides protection of trusted OEM DXE platform initialization code against corruption by other untrusted DXE code running in the pre-OS environment. If present, IsoDXE isolation driver 40 provides optional isolation barrier 41 between OEM extensible code 20 and third party extensible code 70.

Prior to the end of such DXE phase, an isolation driver or kernel such as optional IsoDXE isolation driver 40 may be launched prior to loading of any third party UEFI code. The protection provided by IsoDXE isolation driver 40 ends when boot services are exited. Therefore, IsoDXE isolation driver 40 provides no protection at runtime. As previously mentioned, the present invention does not require the use of an isolation driver such as IsoDXE isolation driver 40, but the present invention may operate in such an environment.

Prior to the end of the DXE phase, DXE pre-SMM phase 24 establishes SMM environment 26 by loading trusted SMM constructor 26C into memory. SMM constructor 26C launches another isolation driver, STM/IsoSMM isolation driver 26I, in accordance with the present invention. The STM/IsoSMM isolation driver 26I protects trusted SMM code 26T from corruption by untrusted SMM code 26U as well as protects resources such as sequestered portions of SMRAM from unauthorized access by untrusted code running in SMM.

STM/IsoSMM isolation driver 26I is launched prior to loading untrusted SMM code 26U. In various embodiments, STM/IsoSMM isolation driver 26I may run in a so-called ring “−1” privilege level, rather than either a system privilege level, i.e., a ring 0 privilege level in which the pre-EFI initialization environment (PEI) and DXE phases operate or a user privilege level, i.e., a ring 3 privilege level in which third party applications run. The ring in which the IsoSMM isolation driver 26I operates may be a higher privilege than ring 0. In embodiments that also include a DXE isolation driver such as IsoDXE isolation driver 40, the IsoDXE isolation driver 40 may operate at the same privilege level as STM/IsoSMM isolation driver 26I.

After such isolation code, including the IsoDXE isolation driver 40 and STM/IsoSMM isolation driver 26I, is executed, the DXE phase may conclude. As described above, the protections provided by IsoDXE isolation driver 40 end when boot services are exited, whereas the protections provided by STM/IsoSMM isolation driver 26I continue during runtime and after the operating system is loaded. When the DXE phase ends, control passes to a boot device selection (BDS) phase in which a boot dispatcher transitions execution to an OS boot phase. The OS boot phase may include a transient system load (TSL) phase in which a transient OS boot loader executes in a transient OS environment and prepares for a final OS boot loading in which the OS code is executed. Accordingly, a run time may proceed in which applications execute using the OS. The STM/IsoSMM isolation driver 26I may continue to act to protect runtime code and other resources from corruption by untrusted SMM code 26U, as described in further detail below. While described in the context of a UEFI environment, the scope of the present invention is not limited in this regard, and in other embodiments, isolation code may be implemented in different code environments.

In some embodiments, a Clark-Wilson integrity analysis of platform interaction with the environment may be performed. Certain controlled data items (CDIs), such as the SMM core code (SMMCore_code_t), other internal state objects for the SMM implementation, and a platform critical region (such as the SMM enhanced debug region of System Management RAM (SMRAM) requested for Intel's Core i7 processors) may be provided with appropriate protection. It is envisioned that the specification of controlled data items to be protected is configurable with the platform, so that some controlled data items may be classified as either trusted or untrusted, depending upon the circumstances. Furthermore, it is envisioned that an operating system may also have controlled data items to be protected by the SMM transfer monitor (STM). For example, in an environment running the Microsoft Windows™ operating system, trusted SMM code 26T such as the SMM transfer monitor (STM) of the present invention may be configured to manage the ntoskemel.exe file as a controlled data item to be protected from untrusted SMM code 26U. Protection of these controlled data items is discussed in further detail below.

Referring again to FIG. 1, an environment includes an SMM transfer monitor (STM) in accordance with one embodiment of the present invention. The embodiment shown in FIG. 1 also includes optional isolation driver IsoDXE isolation driver 40 to protect trusted OEM driver execution environment (DXE) platform initialization code against corruption by other untrusted DXE code running in the pre-OS environment. OEM extensible code 20 is isolated from third-party extensible code 70 via IsoDXE isolation driver 40. As mentioned previously, the SMM transfer monitor of the present invention may operate in a standard DXE environment as well as in the environment provided in FIG. 1 where DXE initialization code is isolated during the pre-boot environment.

OEM extensible code 20 may include security (SEC) and pre-EFI initialization environment (PEI) phases 22 which may execute from code present in a non-volatile storage 15, such as platform flash storage. Further code stored in storage 15 may also implement a DXE phase 24. DXE phase 24 initiates SMM phase 26 by launching trusted SMM constructor 26C included in trusted SMM code 26T, which may also be also stored in non-volatile storage 15. SMM constructor 26C launches the trusted STM/IsoSMM isolation driver 26I to provide isolation barrier 42 between trusted SMM code 26T and untrusted SMM code 26U. After isolation barrier 42 is erected, trusted SMM code 26T may also launch untrusted SMM code 26U; for example, some SMM drivers may be considered to be untrusted and may be launched only after isolation barrier 42 is erected.

Still further, an additional DXE phase 28 may execute both DXE pre-SMM code 27 and DXE post SMM code 29. After such execution, as shown in FIG. 1, third party extensible code 70 may execute. Such code may be located, e.g., in a mass storage device 85 such as disk storage. As shown in FIG. 1, third party extensible code 70 may include an EFI pre-boot phase 72, a boot manager 74 which may perform boot device selection, and an OS loader 76. Third party extensible code 70 may further include an OS kernel 82 and EFI runtime services 84, in which EFI variables may be used to pass data down to other code executing within system 10. Note that the code modules present in third party extensible code 70, specifically boot manager 74, OS loader 76, OS kernel 82, and EFI runtime services 84 may execute in ring 0 privilege level. Thus all of these code modules may provide a post-EFI boot services compartment 90 for execution in this privilege mode. Although not shown in FIG. 1, various third party application code may execute in ring 3 using the services in compartment 90. While shown with this particular implementation in the embodiment of FIG. 1, the scope of the present invention is not limited in this regard.

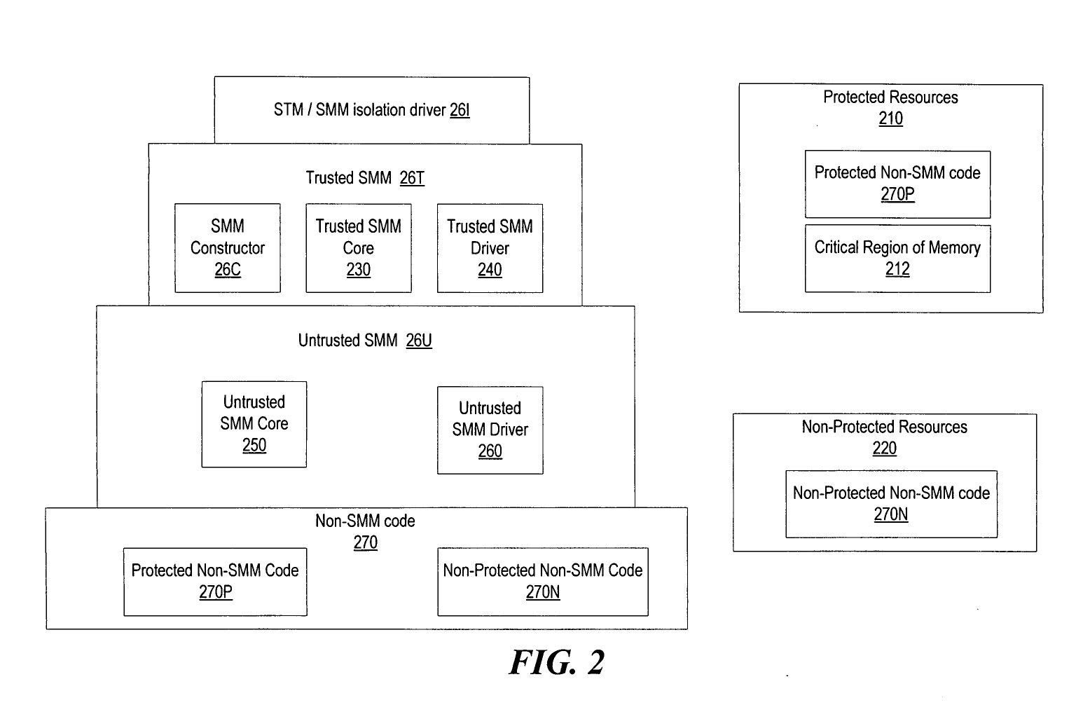

Because SMM code persists at runtime, the isolation barrier 42 provided by STM/IsoSMM isolation driver 26I provides additional protection to various components of system 10. The protections provided by STM/IsoSMM isolation driver 26I are described in further detail below with reference to FIG. 2.

FIG. 2 shows a hierarchy of privilege and resource protection of components of the system of FIG. 1 in accordance with one embodiment of the invention. Components are arranged in order of privilege levels, with STM/SMM isolation driver 26I at the top, indicating the highest privilege level; trusted SMM code 26T at the next-highest privilege level; untrusted SMM code 26U at the next privilege level; and non-SMM code 270 at the lowest privilege level. STM/SMM isolation driver 26I enforces policies to protect protected resources 210 from components that do not have permission to access those protected resources. Protected resources 210 include protected non-SMM code 270P and critical region of memory 212. Non-protected resources 220 are not protected by STM/SMM isolation driver 26I and include non-protected, non-SMM code 270N.

In this resource protection scheme, STM/IsoSMM isolation driver 26I protects each level of the hierarchy from components at lower levels in the hierarchy. For example, STM/SMM isolation driver 26I protects trusted SMM code 26T from untrusted SMM code 26U and from non-SMM code 270. STM/SMM isolation driver 26I also protects itself at runtime from components that are lower in the privilege hierarchy, including other trusted SMM code 26T, untrusted SMM code 26U, as well as from non-SMM code 270 (both protected non-SMM code 270P and non-protected non-SMM code 270N).

It is envisioned that these resources to be protected would be specified as part of a critical region of memory and/or particular registers that cannot be accessed by untrusted SMM code 26U. For example, as mentioned previously, portions of System Management Random Access Memory may be protected from access by untrusted SMM code 26U, both during the pre-boot process as well as at runtime. Referring again to FIG. 1, other resources such as DXE post-SMM code 29, may be specified as needing protection from untrusted SMM code 26U. Resources may also be specified as needing protection at runtime, such as EFI runtime services 84 and other data such as a UEFI system table data. Other memory pages may also be registered for protection as a way of protecting code such as memory pages for boot manager 74, OS loader 76, and OS kernel 82.

In addition, data stored in non-volatile storage 15 may also be protected from untrusted SMM code 26U. Because non-volatile storage 15 may serve as a repository for initialization firmware for platform 10, protection of non-volatile storage 15 from being overwritten by untrusted SMM code 26U assures the integrity of the initialization firmware. Finally, certain model-specific registers (MSRs) that control sensitive machine states and functionality, such as power management, could be protected from being overwritten by untrusted SMM code 26U.

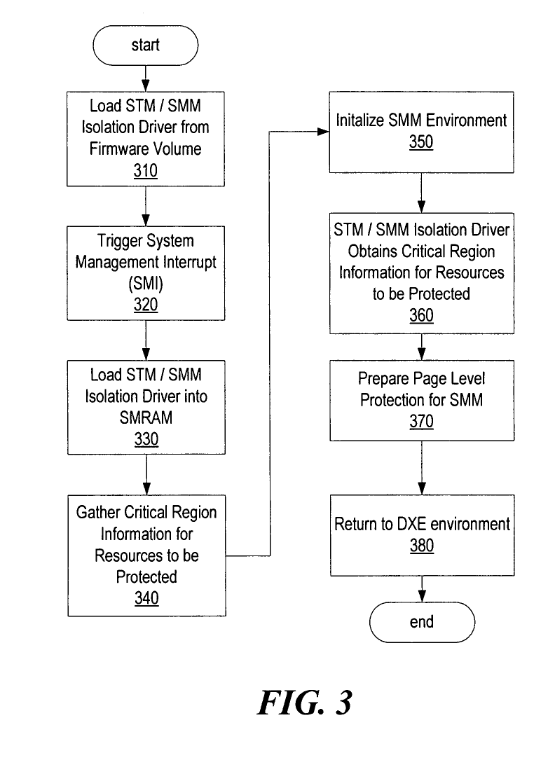

FIG. 3 is a flowchart of the initialization of STM/IsoSMM isolation driver 26I of FIG. 1. The actions described for FIG. 3 are described as being performed by a driver running in the driver execution environment (DXE) phase, and may be performed by either a standard DXE driver or by an isolation driver such as IsoDXE isolation driver 40 of FIG. 1. Control begins when, in “Load STM/SMM Isolation Driver from Firmware Volume” step 310, a DXE driver loads STM/IsoSMM isolation driver 26I from a firmware volume, such as non-volatile storage 15 of FIG. 1, which may be a platform flash storage device, into normal memory. Control proceeds to “Triggers System Management Interrupt (SMI)” step 320, where the DXE driver triggers a system management interrupt (SMI) to cause the system to enter SMM. An SMI can be caused by system software such as a DXE driver, for example, via an I/O access to a location considered special by the motherboard logic (port 0B2h is common). Alternatively, the DXE driver may trigger an SMI by performing a write operation to a location which the firmware has requested that the processor chip act on, or the DXE driver may trigger an SMI by causing motherboard hardware or a chipset to send a signal via a designated pin of the processor chip.

Control then proceeds to “Load STM/SMM Isolation Driver into SMRAM” step 330. Code for STM/IsoSMM isolation driver 26I is loaded from normal memory into system management RAM (SMRAM). In one embodiment, STM/IsoSMM isolation driver 26I is loaded into a portion of the top segment of SMRAM referred to as the monitor segment, or MSEG, which is set aside for the use of an SMM Transfer Monitor (STM).

Control then proceeds to “Gather Critical Region Information for Resources to be Protected” step 340, where the DXE driver gathers critical region information for resources that are to be protected from access by untrusted SMM code. This critical region information may be obtained, for example, from an EFI system table or other system management table. For example, critical region information may be loaded into system management tables during the DXE pre-SMM phase 24 described with reference to FIG. 1. Assets to be protected may be specified in a write-protected, signed UEFI variable such that the system administrator/platform owner/platform manufacturer can instruct the STM/IsoSMM isolation driver 26I which resources should be protected against access by untrusted SMM code 26U. As mentioned above, resources to be protected may include portions of SMRAM, as well as memory pages for UEFT runtime services 84, OS kernel 82, boot manager 74, and OS loader 76, in addition to model-specific registers (MSRs).

Control then proceeds to “Initialize SMM Environment” step 350. In one embodiment, the DXE driver issues a VMCALL, which serves to start a virtual machine monitor to manage the SMM environment. As previously mentioned, in one embodiment, two virtual machine monitors are used—one to manage normal virtualization activity, and a second to manage system management operations in the SMM environment. This VMCALL includes parameters that provide the critical region information gathered in “Gather Critical Region Information for Resources to be Protected” step 340 for initialization of the SMM environment. These parameters may be loaded, for example, into a runtime services component of an SMM system table.

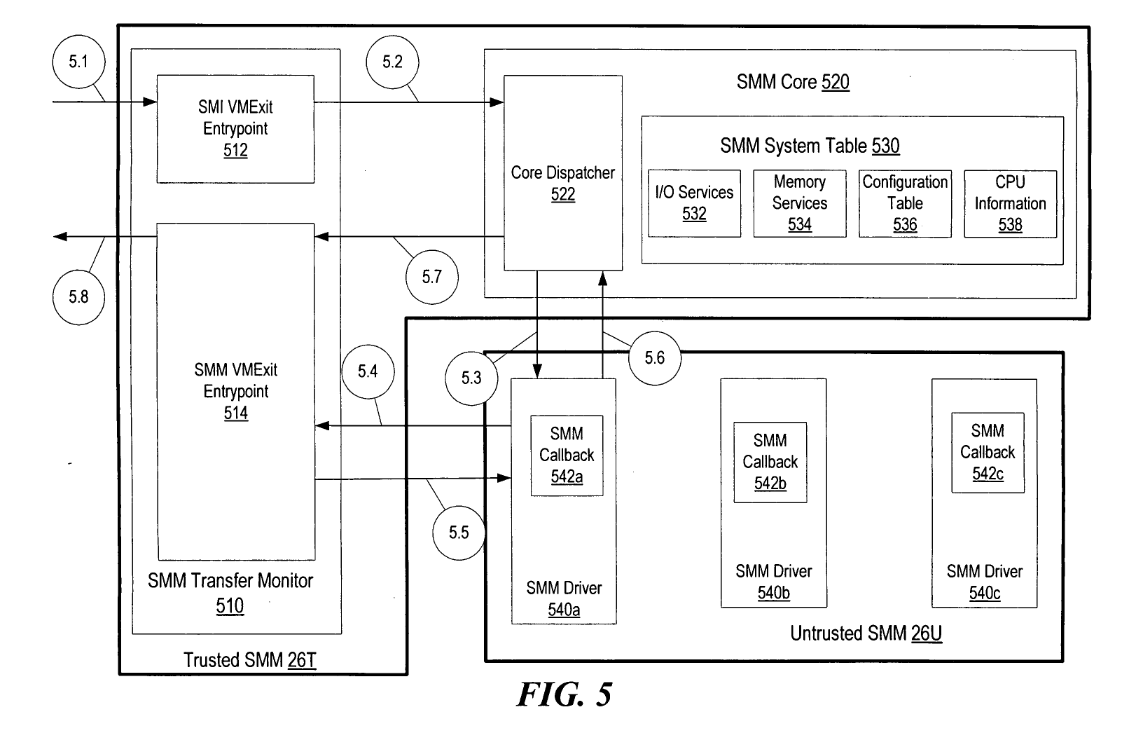

Also as a part of initializing the SMM environment, other portions of the SMM system table may be initialized. This SMM system table is explained in further detail with reference to FIG. 5 below, and may include information for handling I/O services, memory services, a configuration table, and CPU information. Furthermore, the initialization of the SMM environment may include loading various SMM drivers into SMRAM. Each of these SMM drivers may register SMM callback functions to be called when the respective SMM driver causes an SMI to be issued. The operation of SMM drivers and callback functions is described in further detail below with reference to FIG. 5.

Referring again to FIG. 3, control then proceeds from “Initialize SMM Environment” step 350 to “STM/SMM Isolation Driver Obtains Critical Region Information for Resources to be Protected” step 360. For example, STM/IsoSMM isolation driver 26I may obtain the critical region information by reading data from the runtime services component of the SMM system table that was loaded by the DXE driver.

Control then proceeds to “Prepare Page Level Protection for SMM” step 370. Isolation code such as STM/IsoSMM isolation driver 26I may protect various page tables and other structures. For example, embodiments may be used to protect against corruption or hacking of system table data, runtime services code tables, SMM code, and/or a platform critical region of memory (such as the SMM enhanced debug region of System Management RAM (SMRAM) requested for Intel's Core i7 processors), among other malware attempts. In this way, protection of key entries in various systems tables such as the SMM systems table can be realized. Embodiments may further be used to strengthen firmware security features such as protected variables and driver signing. In this way, errant third party driver code may be prevented from usurping SMM services by avoiding patching of application programming interfaces (APIs) in the SMM system table.

In some embodiments, a virtual translation lookaside buffer (vTLB) may be used to manage the access state of each page of the SMM system table, which is a global table used by all SMM drivers, using availability (AVAIL) bits, for example. For example, in one embodiment different page types may be protected using availability bits and other protection structures as follows. Table 1 shows page types and codes to enable page access using isolation code in accordance with an embodiment of the present invention.

TABLE 1

Page type

Use AVAIL bits (9:11) to mark page type.

| | |
|---|---|
| Bit 9: | NEED AUTHORIZED |
| Bit 10: | READ PROTECTED |
| Bit 11: | WRITE PROTECTED |

Active Page table (1:1 mapping present)

For Authorized CODE (Check Write)

Not allow update

For Authorized DATA Write (Check Write)

Check AVAIL bit

For Authorized DATA Read/Write (Check Access)

Check AVAIL bit

In some embodiments, protection using isolation code such as STM/IsoSMM isolation driver 26I may be implemented during a page fault by trapping a page fault during a page table access and determining whether access is allowed according to Table 2, below. As shown in Table 2, based on given status of the AVAIL bits (e.g., bits 9:11) and a type of requested access, access to a given page associated with a table entry may be allowed or denied.

TABLE 2

| PF\IP | AC | AW | AA | C | D |
|---|---|---|---|---|---|
| AC | Y | — | — | N | N |
| AW | Y | — | — | N | N |
| AA | Y | — | — | N | N |
| C | Y | — | — | Y | N |
| D | — | — | — | — | — |

AC: Authorized Code (001b)
AW: Authorized Write Data (101b)
AA: Authorized Access Data (111b)
C: Normal Code (100b or 000b)
D: Normal Data (000b + NEX)
Y: Operation Allow
N: Operation Deny
—: Impossible, need ASSERT

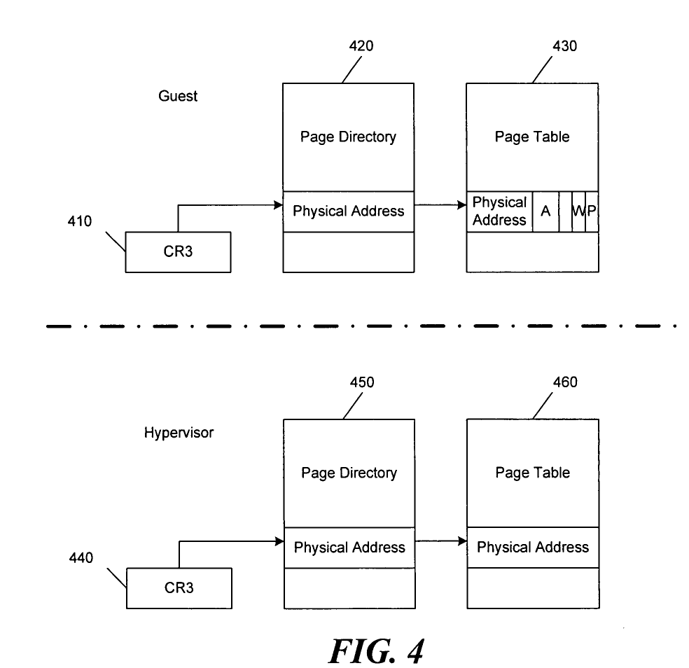

Referring now to FIG. 4, shown is a block diagram of protection of page tables in accordance with an embodiment of the present invention. As shown in FIG. 4, paging mechanisms may be protected. While the scope of the present invention is not limited in this regard, in some embodiments 64-bit address translations may be protected, i.e., using a 4-level paging structure to access physical memory. For example a control register (i.e., control register 3) 410 may include a value that acts as a pointer to access a base of a value in a page directory 420. Each entry in page directory 420 may correspond to a physical address which, in turn may be used to access a page table 430 which may correspond to a guest page table. As shown in FIG. 4, each entry within page table 430 may include a portion of a physical address, AVAIL bits (e.g., bits 9:11), along with a write (W) bit and a protection (P) bit, which may correspond to bits 0 and 1. Thus protection mechanisms may be provided in a guest, e.g., a guest OS or virtual machine (VM) that is controlled by a virtual machine monitor (VMM) or hypervisor (HV). Note that in such embodiments, W and P bits may be set by the hypervisor. Still further, as shown in FIG. 4 in a hypervisor mode of execution, CR3 440 may include a value to access an entry having a physical address within page directory 450 which in turn may be used to access an entry which includes a physical address in page table 460. Thus in hypervisor mode, an active page table may also have a 1:1 mapping with read/write permissions. When accessed, the AVAIL bits, along with the W and P bits may determine whether requesting code can access the associated memory page.

Referring again to FIG. 3 and “Prepare Page Level Protection for SMM” step 370, STM/IsoSMM isolation driver 26I uses a page table to protect resources within the SMM environment. For example, the physical addresses for the portions of SMRAM may be marked as “not present,” thereby preventing access by non-trusted SMM code.

From “Prepare Page Level Protection for SMM” step 370, control passes to “Return to DXE Environment” step 380. The initialization of system tables and other data structures for secure operation of SMM is complete.

FIG. 5 is a block diagram showing runtime operation of a SMM transfer monitor in the SMM environment of FIG. 1 in accordance with an embodiment of the invention. At runtime, a system management interrupt (SMI) may be triggered in various ways. For example, an SMI can be caused by system software via an I/O access to a location considered special by the motherboard logic (port 0B2h is common). Alternatively, system software may trigger an SMI by performing a write operation to a location which the firmware has requested that the processor chip act on, or the system may trigger an SMI by causing motherboard hardware or a chipset to send a signal via a designated pin of the processor chip.

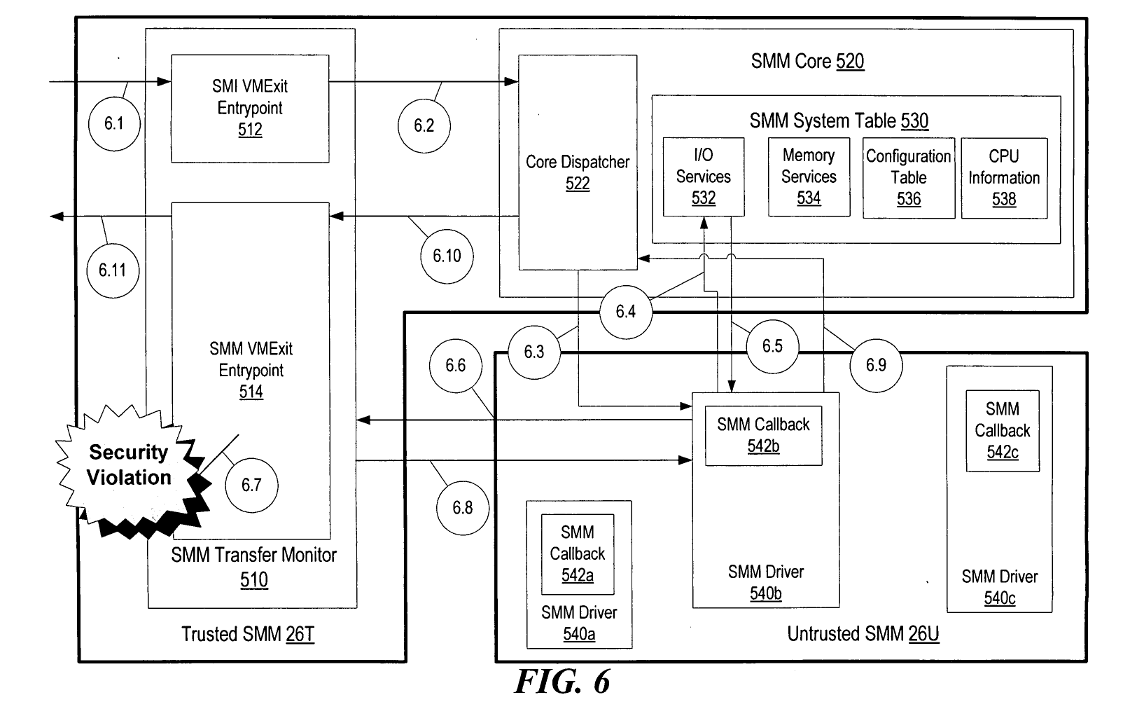

In FIGS. 5 and 6, trusted SMM code 26T is shown as including SMM transfer monitor 510 as well as SMM core 520 and core dispatcher 522 (along with SMM system table 530, which is initialized by SMM transfer monitor 510). Untrusted SMM code 26U includes SMM drivers 540a, 540b, and 540c. As stated above, it is envisioned that the system is configurable such that SMM code can be designated as trusted or untrusted. The code that captures SMI instructions and establishes the SMM environment, which corresponds to SMM transfer monitor 510, is trusted. Depending upon the circumstances, SMM core 520 and core dispatcher 522 may or may not be trusted.

Upon the occurrence of an SMI, as shown in action 5.1, SMM Transfer Monitor 510 traps the interrupt and transfers control to the SMM environment via SMI VMExit Entrypoint 512. At SMI VMExit Entrypoint 512, the virtual machine monitor (VMM) controlling the SMM environment is entered. STM 510 may use a virtual monitor control structure (VMCS) to establish proper protection of resources. STM 510 ensures that the isolated SMM core 520 is running, verifies the source of the isolated SMM core 520, and prepares the SMM system table 530, including I/O services area 532, memory services area 534, configuration table 536, and CPU information area 538. As part of this preparation, STM 510 prepares the SMM CPU state region in SMRAM, and prepares to launch an SMI handler. STM 510 further initiates a transfer of the SMI to SMM core 520. SMM core 520 may be either a 32-bit core running in SMM protected mode, or a 64-bit core running in long mode. Without the capture of the SMI by SMM Transfer Monitor 510, the SMI would have been transferred directly to SMM core 520 and may have taken control or overwritten a protected resource, including SMM core 520 itself.

In action 5.2, STM 510 delivers the SMI instruction to the core dispatcher 522 within SMM core 520. As a result of processing the SMI instruction, STM 510 may issue an SMM VMResume instruction, which resumes execution of an SMM VMM. Core dispatcher 522 dispatches handling of the SMI instruction to an SMM driver, such as one of SMM drivers 540a, 540b, and 540c. SMM drivers 540a, 540b, and 540c are loaded by SMM core 520 during initialization of the SMM environment. During initialization, each of SMM drivers 540a, 540b, and 540c registers a respective callback function 542a, 542b, and 542c to be called when an SMI occurs.

In action 5.3, core dispatcher 522 dispatches handling of the SMI instruction to SMM driver 540a by calling SMM callback function 542a. In action 5.4, the execution of SMI instruction by SMM callback driver 540a causes STM 510 to check page tables such as the page table 430 of FIG. 4 for authorization of SMM driver 540a to perform the instruction. STM 510 finds that SMM driver 540a is authorized to perform the instruction, and control returns to SMM driver 540a in action 5.5. SMM driver 540a is allowed to proceed with performing the instruction. When the instruction is completed, control returns from SMM driver 540a to core dispatcher 522, as shown in action 5.6. A return from SMM is performed in action 5.7, and control returns to SMM VMExit Entrypoint 514 within STM 510. The SMM VMM is exited, and in action 5.8, processing the SMI is completed, and a VMResume instruction resumes operation of the VM that was executing when the SMI was received.

FIG. 6 is another block diagram showing runtime operation of a SMM transfer monitor in the SMM environment of FIG. 1 while processing a security violation in accordance with an embodiment of the invention. Upon the occurrence of an SMI, as shown in action 6.1, SMM Transfer Monitor 510 traps the interrupt within the isolated SMM environment and transfers control to the SMI VMExit Entrypoint 512. In action 6.2, STM monitor 510 delivers the SMI instruction to the core dispatcher 522 within SMM core 520. In action 6.3, core dispatcher 522 dispatches the SMI instruction to SMM driver 540b by calling SMM callback function 542b. In action 6.4 and 6.5, SMM driver 540b requests I/O services from I/O services component 532 of SMM system table 530. For example, SMM driver 540b may request to access the critical region of SMRAM that is protected from access by untrusted SMM code 26U. In action 6.6, the request for I/O services by SMM callback driver 540a causes STM 510 to check page tables such as the page tables shown in FIG. 3 for authorization of SMM driver 540b to perform the instruction. In this example, however, STM 510 finds that the instruction is not authorized by SMM driver 540b; for example, a security violation may be triggered by hardware if a present bit for SMM driver 540b is not set in the page table such as page table 430 of FIG. 4. In action 6.7, a security violation is found and appropriate action is taken by SMM transfer monitor 510. For example, information about the security violation may be recorded to a TXT.CRASH register and a TXT.RESET instruction may be issued to reset the system. The instruction causing the security violation is ignored, and control returns to SMM driver 540b in action 6.8. Control returns from SMM driver 540b to core dispatcher 522, as shown in action 6.9. A return from SMM is performed in action 6.10, and control returns to SMM VMExit Entrypoint 514 within STM 510. In action 6.11, processing the SMI is completed, and a VMResume instruction resumes operation of the VM that was executing when the SMI was received.

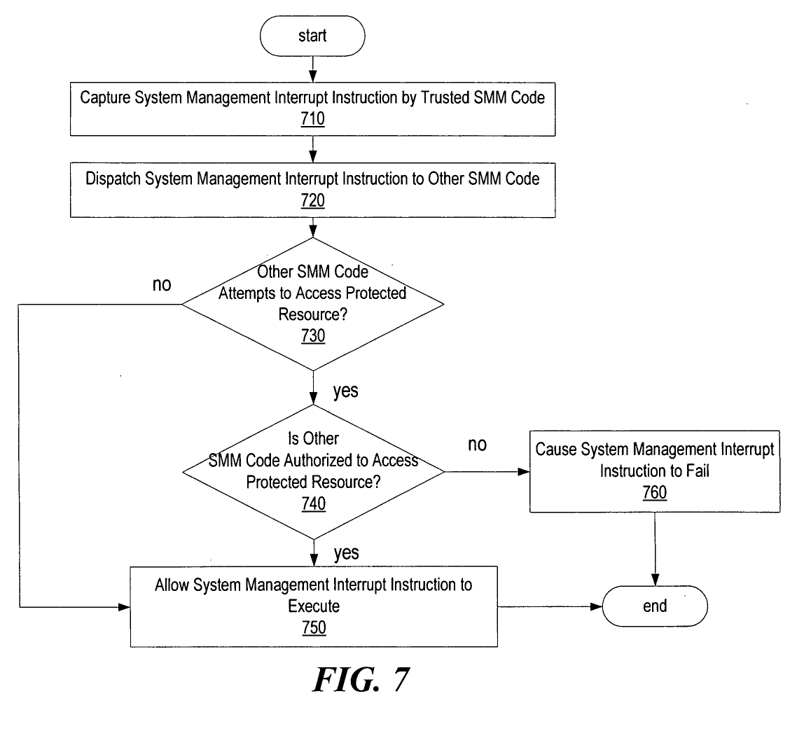

FIG. 7 is a flowchart showing protection of resources by the SMM transfer monitor of the present invention, in accordance with one embodiment of the invention. In “Capture System Management Interrupt Instruction by Trusted SMM Code” step 710, an SMI instruction is captured by trusted SMM code such as SMM transfer monitor 510 of FIG. 5. Control transitions to “Dispatch System Management Interrupt Instruction to Other SMM Code” step 720. The SMI instruction is transferred by SMM transfer monitor 510 to an SMI handler; in the example shown in FIG. 5, the SMI instruction is transferred to core dispatcher 522, which may or may not be trusted code. Core dispatcher 522 then dispatched the SMI instruction to the appropriate SMM driver 540a, 540b, or 540c, which were untrusted code in the example of FIG. 5. Control then proceeds to “Other SMM Code Attempts to Access Protected Resource” decision point 730, where a determination is made whether the other SMM code attempts to access a protected resource. If no attempt to access a protected resource is made by the other SMM code, control proceeds to “Allow System Management Interrupt Instruction to Execute” step 750, where the SMI instruction is allowed to execute and processing the SMI instruction ends. If the other SMM code attempts to access a protected resource at “Other SMM Code Attempts to Access Protected Resource” decision point 730, the authority of the SMM code to access the protected resource is checked at “Is Other SMM Code Authorized to Access Protected Resource” decision point 740. If the other SMM code is authorized to access the protected resource, control proceeds to “Allow System Management Interrupt Instruction to Execute” step 750, where the SMI instruction is allowed to execute and processing the SMI instruction ends. If, however, the other SMM code is not authorized to access the protected resource, control proceeds from “Is Other SMM Code Authorized to Access Protected Resource” decision point 740 to “Cause System Management Interrupt Instruction to Fail” step 760, where the SMI instruction fails and processing the SMI instruction ends.

Note that embodiments may be combined with trusted boot mechanisms such as a secure initialization or an early launch such as a secure launch control policy (LCP) to guarantee that an authorized isolation driver is executing. Thus embodiments may erect an isolation barrier by pushing SMM into ring “−1”, thus breaking compatibility with third party SMM code that operates as if it has unfettered access to ring 0. In this way, embodiments provide for backward compatibility to enable entities such as am OEM SMM core to access page tables, as isolation code may just protect key SMM pages and model specific registers (MSRs) during its execution.

Embodiments of the mechanisms disclosed herein may be implemented in hardware, software, firmware, or a combination of such implementation approaches. Embodiments of the invention may be implemented as computer programs executing on programmable systems comprising at least one processor, a data storage system (including volatile and non-volatile memory and/or storage elements), at least one input device, and at least one output device.

Program code may be applied to input data to perform the functions described herein and generate output information. Embodiments of the invention also include machine-accessible media containing instructions for performing the operations of the invention or containing design data, such as HDL, which defines structures, circuits, apparatuses, processors and/or system features described herein. Such embodiments may also be referred to as program products.

Such machine-accessible storage media may include, without limitation, tangible arrangements of particles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The programs may be implemented in a high level procedural or object oriented programming language to communicate with a processing system. The programs may also be implemented in assembly or machine language, if desired. In fact, the mechanisms described herein are not limited in scope to any particular programming language. In any case, the language may be a compiled or interpreted language.

Presented herein are embodiments of methods and systems for providing an SMM monitor to isolate trusted SMM code from untrusted SMM code and to protect critical regions of SMRAM. While particular embodiments of the present invention have been shown and described, it will be obvious to those skilled in the art that numerous changes, variations and modifications can be made without departing from the scope of the appended claims. Accordingly, one of skill in the art will recognize that changes and modifications can be made without departing from the present invention in its broader aspects. The appended claims are to encompass within their scope all such changes, variations, and modifications that fall within the true scope and spirit of the present invention.

What is claimed is:

1. A method comprising:
capturing a system management interrupt instruction by trusted system management mode code running in a system;
dispatching the system management interrupt instruction to second system management mode code;
in response to an attempt to access a protected resource of the system by the second system management mode code, determining whether the second system management mode code is authorized to access the protected resource;
preventing access to the protected resource by the second system management mode code if the second system management mode code is not authorized to access the protected resource.

2. The method of claim 1 wherein
the determining whether the second system management mode code is authorized to access the protected resource comprises determining whether the second system management mode code is present in an availability bit for a page table entry of a page table for a memory page associated with the protected resource.

3. The method of claim 1, further comprising:
launching an isolation driver to control access to the protected resource before untrusted system management mode code is launched.

4. The method of claim 1, further comprising:
designating a resource of the system as protected by setting an availability bit to unavailable in a page table entry of a page table for a memory page associated with the resource.

5. The method of claim 1 wherein
the protected resource is an operating system kernel.

6. The method of claim 5 wherein
the second system management mode code comprises an OEM SMM driver.

7. The method of claim 1 wherein
the protected resource is flash memory on a motherboard of the system.

8. The method of claim 1 wherein
the protected resource is a driver execution environment driver core.

9. The method of claim 1 wherein
the protected resource is an OEM SMM driver.

10. The method of claim 1 wherein the protected resource is a model-specific register.

11. The method of claim 10 wherein
the second system management mode code comprises an OEM SMM driver.

12. The method of claim 1 wherein
the protected resource is UEFI runtime service code.

13. A system comprising:
a trusted system management mode module to capture a system management interrupt instruction;
a dispatcher to dispatch the system management interrupt instruction to second system management mode code;
a determining module to determine whether the second system management mode code is authorized to access a protected resource of the system;
a preventing module to prevent access to the protected resource by the second system management mode code if the second system management mode code is not authorized to access the protected resource.

14. The system of claim 13 wherein
the determining module determines whether the second system management mode code is authorized to access the protected resource by determining whether the second system management mode code is present in an availability bit for a page table entry of a page table for a memory page associated with the protected resource.

15. The system of claim 13, further comprising:
an isolation driver that is launched to control access to the protected resource before untrusted system management mode code is launched.

16. The system of claim 13, further comprising:
a protection module to designate a resource of the system as protected by setting an availability bit to unavailable in a page table entry of a page table for a memory page associated with the resource.

17. The system of claim 13 wherein
the protected resource is an operating system kernel.

18. The system of claim 13 wherein
the second system management mode code comprises an OEM SMM driver.

19. The system of claim 13 wherein
the protected resource is flash memory on a motherboard of the system.

20. The system of claim 13 wherein
the protected resource is a driver execution environment driver core.

21. The system of claim 13 wherein
the protected resource is an OEM SMM driver.

22. The system of claim 13 wherein
the protected resource is a model-specific register.

23. The system of claim 22 wherein
the second system management mode code comprises an OEM SMM driver.

24. The system of claim 13 wherein
the protected resource is UEFI runtime service code.

25. A computer-readable storage medium comprising:
trusted system management mode instructions to capture a system management interrupt instruction;
dispatching instructions to dispatch the system management interrupt instruction to second system management mode code;
determining instructions to determine whether the second system management mode code is authorized to access a protected resource of a system;
preventing instructions to prevent access to the protected resource by the second system management mode code if the second system management mode code is not authorized to access the protected resource.

26. The computer-readable medium of claim 25 wherein
the determining instructions determine whether the second system management mode code is authorized to access the protected resource comprises by determining whether the second system management mode code is present in an availability bit for a page table entry of a page table for a memory page associated with the protected resource.

27. The computer-readable medium of claim 25, further comprising:
launching instructions to launch an isolation driver to control access to the protected resource before untrusted system management mode code is launched.

28. The computer-readable medium of claim 25, further comprising:
designating instructions to designate a resource of the system as protected by setting an availability bit to unavailable in a page table entry of a page table for a memory page associated with the resource.

29. The computer-readable medium of claim 25 wherein
the protected resource is an operating system kernel.

30. The computer-readable medium of claim 29 wherein
the second system management mode code comprises an OEM SMM driver.

31. The computer-readable medium of claim 25 wherein
the protected resource is flash memory on a motherboard of the system.

32. The computer-readable medium of claim 25 wherein
the protected resource is a driver execution environment driver core.

33. The computer-readable medium of claim 25 wherein
the protected resource is an OEM SMM driver.

34. The computer-readable medium of claim 25 wherein
the protected resource is a model-specific register.

35. The computer-readable medium of claim 34 wherein
the second system management mode code comprises an OEM SMM driver.

36. The computer-readable medium of claim 25 wherein
the protected resource is UEFI runtime service code.
